(19) United States
(12) Patent Application Publication
(10) Pub. No.: US 2009/0225672 A1
(43) Pub. Date: Sep. 10, 2009

(54) METHODS AND APPARATUS TO DETECT WIDEBAND INTERFERENCE IN DIGITAL SUBSCRIBER LINE (DSL) SYSTEMS

(76) Inventors: Xiaochuan Yi, San Ramon, CA (US); Arvind Mallya, Walnut Creek, CA (US); Hua Jiao, Pleasanton, CA (US); Jim Otsuka, San Jose, CA (US)

Correspondence Address: AT&T Legal Department - HFZ;ATTN. Patent Docketing, One AT&T Way, Room 2A-207, Bedminstor, NJ, 07921, US

(21) Appl. No.: 12/043,748

(22) Filed: Mar. 6, 2008

(51) Int. Cl. H04L 12/26; H04B 1/38

(52) U.S. Cl. 370/252; 375/222

(57) ABSTRACT

Methods and apparatus to detect wideband interference in digital subscriber line (DSL) systems are disclosed. An example method comprises retrieving a first plurality of performance parameters for a first time interval for respective ones of a plurality of DSL modems, wherein each of the plurality of DSL modems are associated with respective ones of a plurality of subscriber loops, and comparing each of the performance parameters to a threshold to determine whether two or more of the respective ones of the plurality of subscriber loops experienced respective performance degradations during the first time interval. The example method further comprises determining whether the two or more subscriber loops that experienced the respective performance degradations during the first time interval are communicatively coupled to a common serving terminal, and automatically generating a repair ticket when the two or more subscriber loops that experienced the respective performance degradations during the first time interval are served from the common serving terminal, the repair ticket representing a possible wideband noise interference condition affecting more than one of the plurality of subscriber loops.

### FIELD OF THE DISCLOSURE

This disclosure relates generally to digital subscriber line (DSL) systems and, more particularly, to methods and apparatus to detect wideband interference in DSL systems.

### BACKGROUND

Communication systems using digital subscriber line (DSL) technologies are commonly utilized to provide Internet related services to subscribers, such as, homes and/or businesses (also referred to herein collectively and/or individually as users, customers and/or customer-premises). DSL technologies enable customers to utilize telephone lines (e.g., ordinary twisted-pair copper telephone lines used to provide Plain Old Telephone System (POTS) services) to connect the customer to, for example, a high data-rate broadband Internet network, broadband service and/or broadband content. For example, a communication company and/or service provider may utilize a plurality of modems (e.g., a plurality of DSL modems) implemented by a DSL Access Multiplexer (DSLAM) at a central office (CO) to provide DSL communication services to a plurality of modems located at respective customer-premises. In general, a CO DSL modem receives broadband service content from, for example, a backbone server and forms a digital downstream DSL signal to be transmitted to a customer-premises DSL modem. Likewise, the CO DSL modem receives an upstream DSL signal from the customer-premises DSL modem and provides the data transported in the upstream DSL signal to the backbone server.

### BRIEF DESCRIPTION OF THE DRAWINGS

FIG. 1 is a schematic illustration of an example digital subscriber line (DSL) communication system constructed in accordance with the teachings of the invention.

FIG. 2 illustrates an example manner of implementing the example DSL diagnostic tool of FIG. 1.

FIG. 3 illustrates an example manner of implementing the example data analysis module of FIG. 2.

FIG. 4 is a flowchart representative of example machine accessible instructions that may be carried out by, for example, a processor to implement any or all of the example DSL diagnostic tools of FIGS. 1 and/or 2.

FIG. 5 is a schematic illustration of an example processor platform that may be used and/or programmed to execute the example machine accessible instructions of FIG. 4 to implement any or all of the example DSL diagnostic tools described herein.

### DETAILED DESCRIPTION

Methods and apparatus to detect wideband interference in digital subscriber line (DSL) systems are disclosed. A disclosed example method includes retrieving a first plurality of performance parameters for a first time interval for respective ones of a plurality of DSL modems, wherein each the plurality of DSL modems are associated with respective ones of a plurality of subscriber loops, and comparing each of the performance parameters to a threshold to determine whether two or more of the respective ones of the plurality of subscriber loops experienced respective performance degradations during the first time interval. The example method further comprises determining whether the two or more subscriber loops that experienced the respective performance degradations during the first time interval are communicatively coupled to a common serving terminal, and automatically generating a repair ticket when the two or more subscriber loops that experienced the respective performance degradations during the first time interval are served from the common serving terminal, the repair ticket representing a possible wideband noise interference condition affecting more than one of the plurality of subscriber loops.

A disclosed example apparatus includes a database interface module to retrieve from a DSL performance database a first plurality of performance parameters for a time interval for respective ones of a plurality of DSL modems, wherein the plurality of DSL modems are associated with respective ones of a plurality of subscriber loops, a data analysis module to determine whether two or more of the respective ones of the plurality of subscriber loops experienced a common performance degradation during the time interval based on the first plurality of performance parameters, and a ticket system interface module to generate a repair ticket when the two or more subscriber loops that experienced the respective performance degradation during the time interval are served from the common serving terminal, the repair ticket identifying the common performance degradation.

While methods and apparatus to detect wideband interference in a DSL system are described herein, the example methods and apparatus may, additionally or alternatively, be used to detect other types of interference and/or to detect interference in other types of communication systems. Other example systems include, but are not limited to, those associated with public switched telephone network (PSTN) systems, public land mobile network (PLMN) systems (e.g., cellular), wireless distribution systems, wired or cable distribution systems, coaxial cable distribution systems, Ultra High Frequency (UHF)/Very High Frequency (VHF) radio frequency systems, satellite or other extra-terrestrial systems, cellular distribution systems, power-line broadcast systems, fiber optic networks, passive optical network (PON) systems, and/or any combination and/or hybrid of these devices, systems and/or networks.

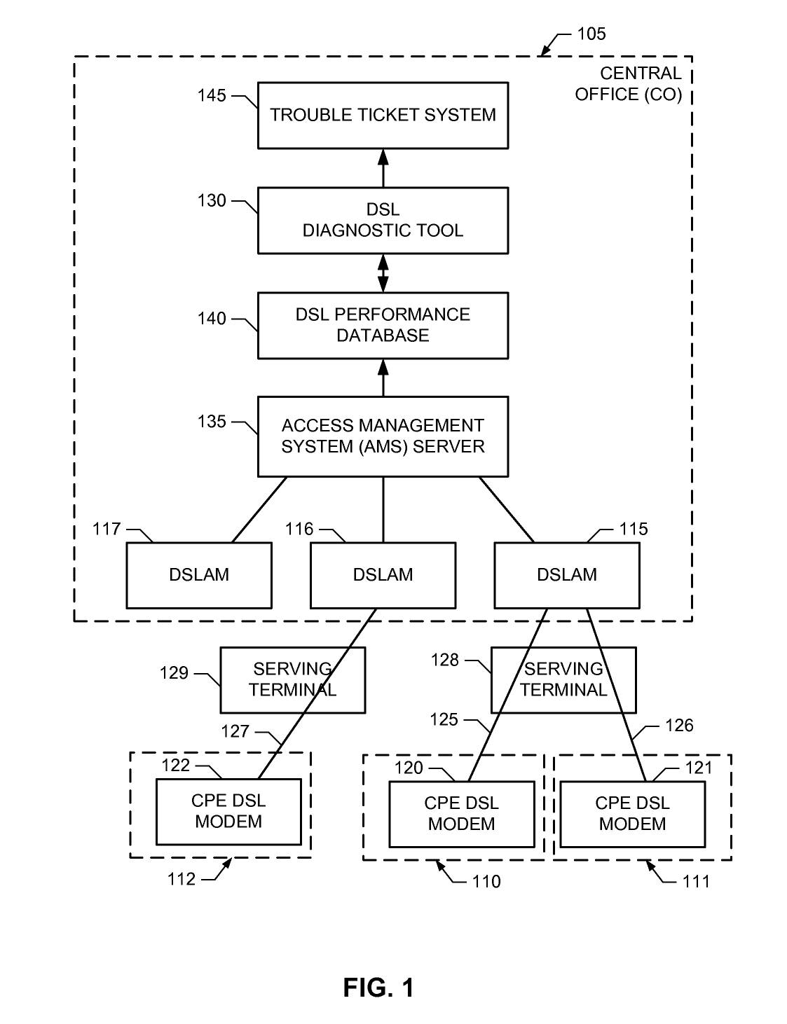

FIG. 1 illustrates an example DSL communication system in which a central office (CO) 105 provides data and/or communication services (e.g., telephone services, Internet services, data services, messaging services, instant messaging services, electronic mail (email) services, chat services, video services, audio services, gaming services, etc.) to one or more customer premises, three of which are designated at reference numerals 110, 111 and 112. To provide DSL communication services to the customer premises 110-112, the example CO 105 of FIG. 1 includes any number and/or type(s) of DSL access multiplexers (DSLAMs) (three of which are designated at reference numerals 115, 116 and 117) and the example customer premises 110-112 include any type(s) of customer-premises equipment (CPE) DSL modems 120, 121 and 122. The example DSLAMs 115-117 of FIG. 1 include and/or implement one or more CO DSL modems (not shown) for respective ones of the customer-premises locations 110-112. The example DSLAMs 115-117, the CO DSL modems within the DSLAMs 115-117, and/or the example CPE, such as DSL modems of FIG. 1 may be implemented, for example, in accordance with the International Telecommunications Union-Telecommunications Sector (ITU-T) G.993.x family of standards for very high-speed DSL (VDSL), and/or the ITU-T G.992.x family of standards for asymmetric DSL (ADSL).

In the illustrated example of FIG. 1, the DSLAM 115 provides DSL services to the DSL modems 120-122 via respective subscriber lines 125, 126 and 127. Subscriber lines are sometimes also referred to in the industry as “wire-pairs”, “subscriber loops” and/or “loops.” While throughout this disclosure reference is made to the example subscriber lines 125, 126 and/or 127 of FIG. 1, a subscriber line (e.g., any of the example subscriber lines 125-127) used to provide a DSL service to a customer-premises location (e.g., any of the locations 110-112) may include and/or be constructed from one or more segments of twisted-pair telephone wire (e.g., a combination of a feeder one (F1) cable, a distribution cable, a drop cable, and/or customer-premises wiring), terminals and/or distributions points (e.g., a serving area interface (SAI), a serving terminal 128, 129, a vault and/or a pedestal). Such segments of twisted-pair telephone wire may be spliced and/or connected end-to-end, and/or may be connected at only one end thereby creating one or more bridged-taps. Regardless of the number, type(s), gauge(s) and/or topology of twisted-pair telephone wires used to construct the example subscriber lines 125-127, they will be referred to herein in the singular form, but it will be understood that the term “subscriber line” may refer to one or more twisted-pair telephone wire segments and may include one or more bridged taps.

The example serving terminals 128, 129 of FIG. 1 route, couple and/or connect subscriber lines 125-127 to CPE DSL modems 120-122 for and/or within a particular geographic area (e.g., a neighborhood and/or a street). For example, the example serving terminal 128 couples a first-wire pair 125 of a distribution cable 123 to the customer premises 110, and couples a second-wire pair 126 of the distribution cable 123 to the customer premises 111. In this manner, the example serving terminal 128 implements a wiring distribution point, terminal and/or pedestal. Each of the example CPE DSL modems 120-122 of FIG. 1 are “served” by and/or associated with a particular serving terminal 128, 129 that is used to route a subscriber line 125-126 to its respective CPE DSL modem 120-122. Because the example customer premises 110 and 111 of FIG. 1 are served by a common serving terminal 128 and thereby geographically near to each other, the subscriber lines 125 and 126 may be exposed to one or more sources of noise, interference and/or performance degradation. Example common sources that may affect subscriber lines 125-127 that are commonly located include, but are not limited to, a AM radio transmitter, a HAM radio transmitter, crosstalk noise with a distribution cable bundle, a defective television and/or a defective digital versatile disc (DVD) player. It has been observed in the field, and experimentally verified, that a defective television and/or DVD player can create radio frequency interference (RFI) that causes dramatic degradations in downstream performance (e.g., from 1.5 Million bits per second (Mb/s) to 448 thousand bits per second (kb/s)) for multiple customer-premises 110-112 in the vicinity of a particular serving terminal 128, 129. Such noise sources are wideband in nature and cause interference into a large number (e.g., hundreds) of the sub-carriers available to form a downstream DSL signal, while narrowband noise sources (e.g., a AM radio transmitter) affect fewer sub-carriers (e.g., a few). In many instances, when a defective television is turned on, nearby DSL modems 120-122 will experience a burst or errors and/or lose synchronization, retrain and then regain synchronization albeit at a much lower maximum downstream data rate. However, once a defective television or DVD player is identified, the interference can be substantially reduced and/or eliminated by, for example, providing appropriate filtering and/or blocking on coaxial cables, antennas and/or power lines. For instance, by installing a Tripp-Lite isobar surge protector.

In traditional DSL communication systems, interference, noise and/or performance problems are diagnosed and/or resolved once a subscriber contacts a customer service and/or technical support line to report a problem for a particular subscriber line. However, such problems must often be resolved without the benefit of information concerning other potentially affected subscriber lines. Such traditional processes can result in decreased customer satisfaction and may be unable to properly correct reported problems when the source of a reported problem is intermittent in nature.

In contrast, the methods and apparatus described herein proactively monitor and/or review the aggregate and/or overall performance of all subscriber lines (e.g., the example subscriber lines 125-127) of a CO (e.g., the example CO 105) at periodic or a periodic intervals to detect the intermittent and/or regular occurrence of performance degradations experienced by multiple subscriber lines 125-127 of a serving terminal 128, 129 due to wideband noise sources, such as a defective television and/or DVD player. Once such wideband noise sources are identified, a trouble and/or repair ticket is automatically generated such that a service technician can identify and/or mitigate the issue, sometimes prior to subscribers being aware and/or reporting that a problem exists. In this way, a service provider can enhance the quality of the DSL services provided via the CO 105 and the subscriber's perception of the same.

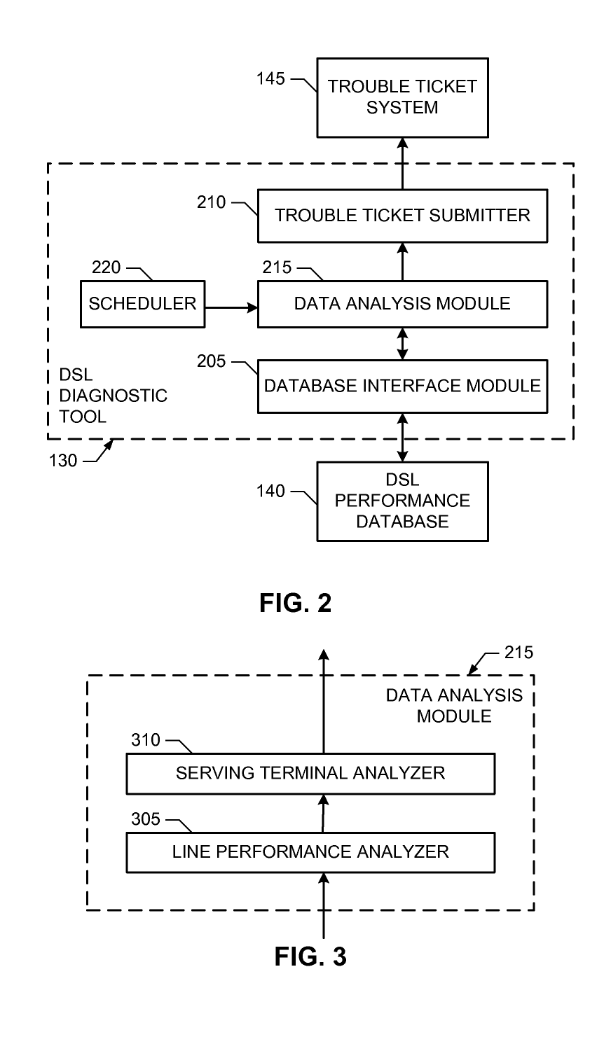

To proactively monitor and/or diagnosis a subscriber line (e.g., one of the example subscriber lines 125-127), the example DSL communication system of FIG. 1 includes a DSL diagnostic tool 130. Based on a schedule (e.g., hourly, daily, weekly, etc.) the example DSL diagnostic tool 130 of FIG. 1 automatically analyzes historical and/or current performance data associated with each of the subscriber lines 125-127, for example, is collected from the example DSLAMs 115-117 by an access management system (AMS) server 135 and stored in a performance database 140. In some instances the performance data analyzed are aggregate performance data and/or aggregate performance parameters that reflect the overall operating condition of each of the subscriber lines 125-127. Using the aggregate performance data obtained from the DSL performance database 140 (e.g., maximum attainable downstream data rates, and/or error rates and/or counters), the example DSL diagnostic tool 130 attempts to identify whether a serving terminal 128, 129 is affected by a wideband noise and/or interference source that is affecting multiple subscriber lines 125-127 associated with the serving terminal 128, 129. The example DSL diagnostic tool 130 correlates the time(s) and/or time interval(s) at which subscriber lines 125-127 of a particular serving terminal 128, 129 are and/or have experienced significant degradations in performance (e.g., a fifty percent decrease in maximum attainable downstream data rate or a marked increase in errors). Two or more subscriber lines 125-127 of a serving terminal 128, 129 experiencing significant performance degradations during the same time interval(s) and/or at the same time(s) is indicative of a wideband noise source, such as a defective television or DVD player. When such a wideband noise and/or interference source is detected, the example DSL diagnostic tool 130 of FIG. 1 automatically generates and/or submits a repair ticket to a trouble ticket system 145 so that an appropriate technician can be dispatched to locate, mitigate and/or resolve the problem (e.g., identify a faulty television and install an isolating surge protector). An example manner of implementing the example DSL diagnostic tool 130 of FIG. 1 is described below in connection with FIGS. 2 and/or 4.

To collect performance data, the example CO 105 of FIG. 1 includes the example AMS server 135. The example AMS server 135 of FIG. 1 periodically or aperiodically collects performance data (e.g., maximum attainable data rates, error counters, estimated loop lengths, DSL connection rates, loop attenuation values, error rates, signal-to-noise ratios, bit allocations, noise margins, DSL modem configurations, etc.) from the example DSLAMs 115-117 and/or customer-premises DSL modems 120, 121 communicatively coupled to the DSLAMs 115-117.

To manage repair and/or maintenance reports, the example CO 105 of FIG. 1 includes the example trouble ticket system 145. The example trouble ticket system 145 of FIG. 1 implements an application programming interface (API) via which the example DSL diagnostic tool 130 can submit a trouble ticket. The example trouble ticket system 145 also routes a submitted trouble ticket to a suitable repair, customer support and/or technical support person for resolution, and tracks the resolution of trouble tickets.

While in the illustrated example of FIG. 1, the example DSLAMs 115-117, the example DSL diagnostic tool 130, the example AMS server 135, the example DSL performance database 140, and the example trouble ticket system 145 are illustrated in connection with the example CO 105, one or more of the DSL diagnostic tool 130, the example AMS server 135, the example DSL performance database 140, and/or the example trouble ticket system 145 may be located and/or implemented separately from the CO 105. For example, the DSL diagnostic tool 130, the example DSL performance database 140, and/or the example trouble ticket system 145 may be located and/or implemented at a customer service location (not shown), which is communicatively coupled to the AMS 135 at the CO 105. Further any number of DSLAMs 115-117 may be implemented and/or located at a CO. Moreover, a DSLAM 115-117 may be implemented and/or located at a remote terminal (not shown), which is communicatively coupled to the example DSL diagnostic tool 130 via an AMS server (e.g., the example AMS server 135 at a CO (e.g., the example CO 105).

FIG. 2 illustrates an example manner of implementing the example DSL diagnostic tool 130 of FIG. 1. To interact with the example performance database 140, the example DSL diagnostic tool 130 of FIG. 2 includes a database interface module 205. The example database interface module 205 of FIG. 2 implements one or more APIs to allow other elements of the example DSL diagnostic tool 130 to perform queries of the example performance database 140 to, for example, obtain performance data associated with a subscriber loop.

To interact with the example trouble ticket system 145, the example DSL diagnostic tool 130 of FIG. 2 includes a trouble ticket submitter 210. The example trouble ticket submitter 210 of FIG. 2 submits repair tickets for serving terminals and/or subscriber lines identified by a data analysis module 215. The example trouble ticket submitter 210 submits a trouble ticket by, for example, accessing and/or utilizing an API provided and/or implemented by the example trouble ticket system 145. In some examples, the trouble ticket submitter 210 includes diagnostic data (e.g., which subscriber lines are affected, time(s) of day when the subscriber lines were affected by wideband noise, etc.) as part of a submitted trouble ticket. Such included information may be used by, for example, a repair technician while diagnosing a detected problem.

To analyze performance data, the example DSL diagnostic tool 130 of FIG. 2 includes a data analysis module 215 and a scheduler 220. The example scheduler 220 of FIG. 1 directs the example data analysis module 215 to periodically or aperiodically analyzes historical and/or current performance data stored in the DSL performance database 140. The times set by the scheduler 220 may be programmed by a technician.

Using the performance data obtained from the DSL performance database 140 (e.g., maximum attainable downstream data rates, error rates and/or error counters), the example data analysis module 215 of FIG. 2 attempts to proactively identify whether a serving terminal is affected by a wideband noise and/or interference source that is affecting multiple subscriber lines associated with the serving terminal. The example data analysis module 215 correlates the time(s) and/or time interval(s) at which subscriber lines of a particular serving terminal are and/or have experienced significant degradations in performance (e.g., a fifty percent decrease in maximum attainable downstream data rate or a marked increased in errors). When such a wideband noise and/or interference source is detected, the example data analysis module 215 notifies the example trouble ticket submitter 210 of the occurrence. The trouble ticket submitter 220 responds by automatically submitting a repair ticket to the trouble ticket system 145 so that an appropriate technician can be dispatched to locate, mitigate and/or resolve the problem (e.g., identify a faulty television and install an isolating surge protector). An example manner of implementing the example data analysis module 215 of FIG. 2 is described below in connection with FIG. 3.

While an example manner of implementing the example DSL diagnostic tool 130 of FIG. 1 has been illustrated in FIG. 2, one or more of the elements, processes and/or devices illustrated in FIG. 2 may be combined, divided, re-arranged, omitted, eliminated and/or implemented in any other way. Further, the example database interface module 205, the example trouble ticket submitter 210, the example data analysis module 215, the example scheduler 220 and/or, more generally, the example DSL diagnostic tool 130 of FIG. 2 may be implemented by hardware, software, firmware and/or any combination of hardware, software and/or firmware. Thus, for example, any or the example database interface module 205, the example trouble ticket submitter 210, the example data analysis module 215, the example scheduler 220 and/or, more generally, the example DSL diagnostic tool 130 may be implemented by one or more circuit(s), programmable processor(s), application specific integrated circuit(s) (ASIC(s)), programmable logic device(s) (PLD(s)) and/or field programmable logic device(s) (FPLD(s)), etc. When any of the appended claims are read to cover a purely software implementation, at least one of the example database interface module 205, the example trouble ticket submitter 210, the example data analysis module 215, the example scheduler 220 and/or, more generally, the example DSL diagnostic tool 130 are hereby expressly defined to include a tangible medium such as a memory, a DVD, a compact disc (CD), etc. Further still, the example DSL diagnostic tool 130 may include one or more elements, processes and/or devices in addition to, or instead of, those illustrated in FIG. 2, and/or may include more than one of any or all of the illustrated elements, processes and devices.

FIG. 3 illustrates an example manner of implementing the example data analysis module 215 of FIG. 2. To identify degraded subscriber lines (e.g., any of the example subscriber lines 125-127 of FIG. 1), the example data analysis module 215 of FIG. 3 includes a line performance analyzer 305. The example line performance analyzer 305 of FIG. 3 processes a performance data record (e.g., containing a plurality of maximum attainable data rates for respective ones of a plurality of time intervals and/or instants) for each subscriber line of a CO to create a list of potential times and/or time intervals when a serving terminal may have been affected by a wideband noise and/or interference source.

To identify affected serving terminals, the example data analysis module 215 of FIG. 3 includes a serving terminal analyzer 310. The example serving terminal analyzer 310 of FIG. 3 processes the list created by the example line performance analyzer 305 to determine whether two or more subscriber lines of a serving terminal experienced significant performance degradation during the same time interval(s) and/or at the same time instant(s). For such affected serving terminals, the example serving terminal analyzer 310 (a) compiles a tabulation of the affected subscriber lines and the times at which the subscriber lines experienced degraded performance, and (b) notifies the example trouble ticket submitter 210 of FIG. 2 of the occurrence(s) and identifies the affected serving terminal(s).

While an example manner of implementing the example data analysis module 215 of FIG. 2 has been illustrated in FIG. 3, one or more of the elements, processes and/or devices illustrated in FIG. 3 may be combined, divided, re-arranged, omitted, eliminated and/or implemented in any other way. Further, the example line performance analyzer 305, the example serving terminal analyzer 310 and/or, more generally, the example data analysis module 215 of FIG. 3 may be implemented by hardware, software, firmware and/or any combination of hardware, software and/or firmware. Thus, for example, any or the example line performance analyzer 305, the example serving terminal analyzer 310 and/or, more generally, the example data analysis module 215 may be implemented by one or more circuit(s), programmable processor(s), ASIC(s), PLD(s) and/or FPLD(s), etc. When any of the appended claims are read to cover a purely software implementation, at least one of the example line performance analyzer 305, the example serving terminal analyzer 310 and/or, more generally, the example data analysis module 215 are hereby expressly defined to include a tangible medium such as a memory, a DVD, a CD, etc. Further still, the example analysis module 215 of FIG. 3 may include one or more elements, processes and/or devices in addition to, or instead of, those illustrated in FIG. 3, and/or may include more than one of any or all of the illustrated elements, processes and devices.

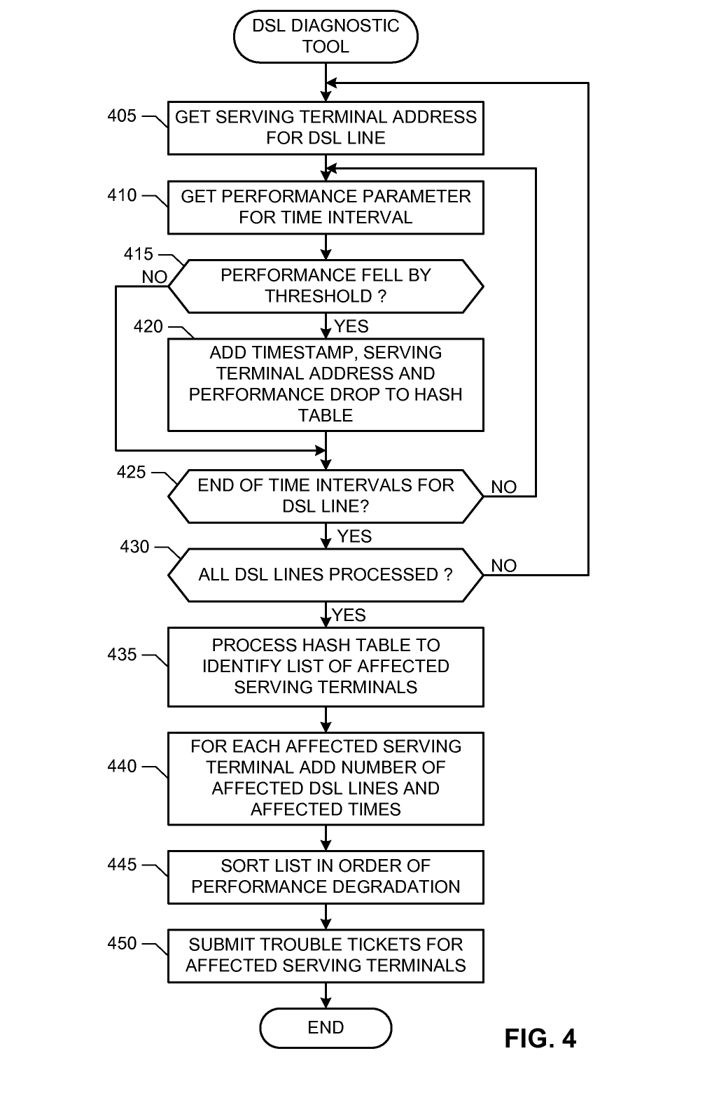

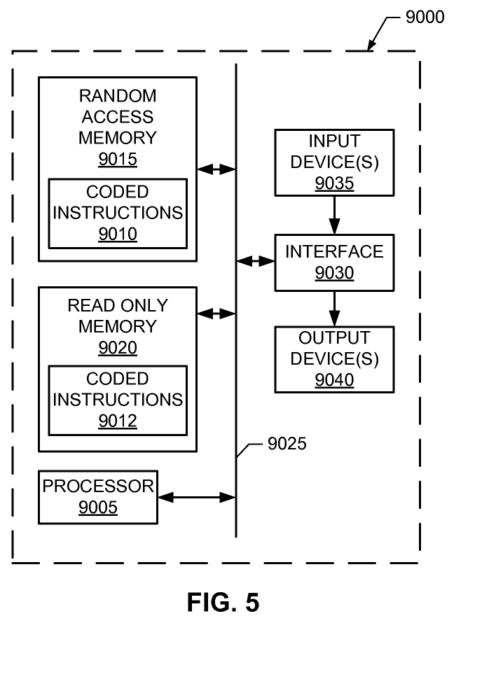

FIG. 4 is a flowchart representative of example machine accessible instructions that may be carried out to implement any or all of the example DSL diagnostic tools 130 of FIGS. 1 and/or 2. The example machine accessible instructions of FIG. 4 may be carried out by a processor, a controller and/or any other suitable processing device. For example, the example machine accessible instructions of FIG. 8 may be embodied in coded instructions stored on a tangible medium such as a flash memory, a read-only memory (ROM) and/or random-access memory (RAM) associated with a processor (e.g., the example processor 9005 discussed below in connection with FIG. 5). Alternatively, some or all of the example machine accessible instructions of FIG. 4 may be implemented using any combination(s) of circuit(s), ASIC(s), PLD(s), FPLD(s), discrete logic, hardware, firmware, etc. Also, some or all of the example machine accessible instructions of FIG. 4 may be implemented manually or as any combination of any of the foregoing techniques, for example, any combination of firmware, software, discrete logic and/or hardware. Further, although the example operations of FIG. 4 are described with reference to the flowchart of FIG. 4, many other methods of implementing the operations of FIG. 4 may be employed. For example, the order of execution of the blocks may be changed, and/or one or more of the blocks described may be changed, eliminated, sub-divided, or combined. Additionally, any or all of the example machine accessible instructions of FIG. 4 may be carried out sequentially and/or carried out in parallel by, for example, separate processing threads, processors, devices, discrete logic, circuits, etc.

The example machine accessible instructions of FIG. 4 begin when the example scheduler 220 of FIG. 2 directs the example DSL diagnostic 130 tool to process performance data to identify potential wideband interference in a DSL system. The example data interface module 205 queries the example DSL performance database 140 to obtain the address of a serving terminal associated with a particular subscriber line (e.g., any of the example subscriber lines 125-127) (block 405). The data interface module 205 obtains the first performance parameter (e.g., maximum attainable data rate) corresponding to a first time interval and/or instant from a performance data record for the given subscriber line (block 410).

The example line performance analyzer 305 of FIG. 3 determines whether the first performance parameter indicates that performance was significantly degraded (e.g., a fifty percent drop in maximum attainable data rate) compared to a previous time instant (e.g., a week ago) (block 415). If a significant performance degradation occurred (block 415), the line performance analyzer 305 adds an entry to a hash table containing a timestamp corresponding to the first time interval and the serving terminal address (block 420). If a significant performance degradation did not occur (block 415), control proceeds to block 425 without adding an entry to the hash table. If there are more performance parameters in the performance data record for the given subscriber loop (block 425), control returns to block 410 to process the next performance data entry.

If all of the performance data for the given subscriber loop has been processed (block 425), the line performance analyzer 305 determines if the performance data for all subscriber loops has been processed (block 430). If all subscriber loops have not been processed (block 430), control returns to block 405 to process the next subscriber loop.

If all subscriber loops have been processed (block 430), the example serving terminal analyzer 310 of FIG. 3 processes the hash table to identify a list of affected serving terminals (i.e., those serving terminals having two or more subscriber loops affected during the same time instant) (block 435). For each affected serving terminal, the serving terminal analyzer 310 creates a list of the affected subscriber loops for each time instant and/or interval where wideband noise was detected (block 440).

The serving terminal analyzer 310 sorts the list of affected serving terminals based on the extent (e.g., number of affected subscriber loops, number of affected time intervals, etc.) (block 445). The example trouble ticket submitter 210 of FIG. 2 then submits trouble tickets for the affected serving terminals (block 450). In some examples, the trouble ticket submitter 210 only automatically submits trouble tickets for severely affected serving terminals (e.g., those terminals in which more than 20% of subscriber loops are affected). Control then exits from the example machine accessible instructions of FIG. 4.

FIG. 5 is a schematic diagram of an example processor platform 9000 that may be used and/or programmed to implement all or a portion of any or all of the example DSL diagnostic tool 130, the example database interface module 205, the example trouble ticket submitter 210, the example data analysis module 215, the example scheduler 220, the example line performance analyzer 305, and/or the example serving terminal analyzer 310 of FIGS. 1, 2, and/or 3. For example, the processor platform 9000 can be implemented by one or more general purpose processors, processor cores, microcontrollers, etc.

The processor platform 9000 of the example of FIG. 5 includes at least one general purpose programmable processor 9005. The processor 9005 executes coded instructions 9010 and/or 9012 present in main memory of the processor 9005 (e.g., within a RAM 9015 and/or a ROM 9020). The processor 9005 may be any type of processing unit, such as a processor core, a processor and/or a microcontroller. The processor 9005 may execute, among other things, the example machine accessible instructions of FIG. 4 to implement the example methods and apparatus described herein.

The processor 9005 is in communication with the main memory (including a ROM 9020 and/or the RAM 9015) via a bus 9025. The RAM 9015 may be implemented by DRAM, SDRAM, and/or any other type of RAM device, and ROM may be implemented by flash memory and/or any other desired type of memory device. Access to the memory 9015 and the memory 9020 may be controlled by a memory controller (not shown). One or both of the example memories 9015 and 9020 may be used to implement the example DSL performance database 140 of FIG. 1.

The processor platform 9000 also includes an interface circuit 9030. The interface circuit 9030 may be implemented by any type of interface standard, such as an external memory interface, serial port, general purpose input/output, etc. One or more input devices 9035 and one or more output devices 9040 are connected to the interface circuit 9030. The input devices 9035 and/or output devices 9040 may be used to, for example, implement the example database interface module 205 and/or the example trouble ticket submitter 210 of FIG. 2.

Of course, the order, size, and proportions of the memory illustrated in the example systems may vary. Additionally, although this patent discloses example systems including, among other components, software or firmware executed on hardware, such systems are merely illustrative and should not be considered as limiting. For example, it is contemplated that any or all of these hardware and software components could be embodied exclusively in hardware, exclusively in software, exclusively in firmware or in some combination of hardware, firmware and/or software. Accordingly, the above described examples are not the only way to implement such systems.

At least some of the above described example methods and/or apparatus are implemented by one or more software and/or firmware programs running on a computer processor. However, dedicated hardware implementations including, but not limited to, an ASIC, programmable logic arrays and other hardware devices can likewise be constructed to implement some or all of the example methods and/or apparatus described herein, either in whole or in part. Furthermore, alternative software implementations including, but not limited to, distributed processing or component/object distributed processing, parallel processing, or virtual machine processing can also be constructed to implement the example methods and/or apparatus described herein.

It should also be noted that the example software and/or firmware implementations described herein are optionally stored on a tangible storage medium, such as: a magnetic medium (e.g., a disk or tape); a magneto-optical or optical medium such as a disk; or a solid state medium such as a memory card or other package that houses one or more read-only (non-volatile) memories, random access memories, or other re-writable (volatile) memories; or a signal containing computer instructions. A digital file attachment to e-mail or other self-contained information archive or set of archives is considered a distribution medium equivalent to a tangible storage medium. Accordingly, the example software and/or firmware described herein can be stored on a tangible storage medium or distribution medium such as those described above or equivalents and successor media.

To the extent the above specification describes example components and functions with reference to particular devices, standards and/or protocols, it is understood that the teachings of the invention are not limited to such devices, standards and/or protocols. Such systems are periodically superseded by faster or more efficient systems having the same general purpose. Accordingly, replacement devices, standards and/or protocols having the same general functions are equivalents which are intended to be included within the scope of the accompanying claims.

Although certain example methods, apparatus and articles of manufacture have been described herein, the scope of coverage of this patent is not limited thereto. On the contrary, this patent covers all methods, apparatus and articles of manufacture fairly falling within the scope of the appended claims either literally or under the doctrine of equivalents.

What is claimed is:

1. A method comprising:
retrieving a first plurality of performance parameters for a first time interval for respective ones of a plurality of digital subscriber line (DSL) modems, wherein each of the plurality of DSL modems are associated with respective ones of a plurality of subscriber loops;
comparing each of the performance parameters to a threshold to determine whether two or more of the respective ones of the plurality of subscriber loops experienced respective performance degradations during the first time interval;
determining whether the two or more subscriber loops that experienced the respective performance degradations during the first time interval are communicatively coupled to a common serving terminal; and
automatically generating a repair ticket when the two or more subscriber loops that experienced the respective performance degradations during the first time interval are served from the common serving terminal, the repair ticket representing a possible wideband noise interference condition affecting more than one of the plurality of subscriber loops.

2. A method as defined in claim 1, wherein the common serving terminal electrically couples a first wire-pair of a distribution cable to a first of the two or more subscriber loops that experienced the respective performance degradations, and electrically couples a second wire-pair of the distribution cable to a second of the two or more subscriber loops that experienced the respective performance degradations.

3. A method as defined in claim 2, wherein the common serving terminal electrically couples the first wire-pair of the distribution cable to the first of the two or more subscriber loops via a drop-cable which is electrically coupled to the first wire-pair at the common serving terminal and to the first of the two or more subscriber loops.

4. A method as defined in claim 2, wherein the distribution cable comprises a feeder one cable.

5. A method as defined in claim 1, further comprising:
retrieving a second plurality of performance parameters for a second time interval for the respective ones of the plurality of DSL modems;
comparing each of the performance parameters in the second plurality to the threshold to determine whether the two or more of the respective ones of the plurality of subscriber loops experienced respective performance degradations during the second time interval;
automatically updating the repair ticket when the two or more subscriber loops that experienced the respective performance degradations during the second time interval are served from the common serving terminal.

6. A method as defined in claim 1, wherein the method is performed on a scheduled basis to proactively detect and identify a wideband noise interfering with the two or more affected subscriber lines communicatively coupled to the common serving terminal.

7. A method as defined in claim 1, wherein the possible wideband noise interference is caused by a defective television.

8. A method as defined in claim 7, further comprising inserting a block filter at the defective television to mitigate the possible wideband noise interference.

9. A method as defined in claim 1, wherein the first plurality of performance parameters represent aggregate performance characteristics for respective ones of the plurality of subscriber lines.

10. A method as defined in claim 1, wherein the first plurality of performance parameters represent error counters for respective ones of the plurality of subscriber lines.

11. A method as defined in claim 1, wherein the first plurality of performance parameters represent changes in maximum achievable data rates for respective ones of the plurality of subscriber lines.

12. A method as defined in claim 11, wherein the threshold represents a fifty percent decrease in a maximum achievable data rate.

13. An apparatus comprising:
a database interface module to retrieve from a digital subscriber line (DSL) performance database a first plurality of performance parameters for a time interval for respective ones of a plurality of DSL modems, wherein the plurality of DSL modems are associated with respective ones of a plurality of subscriber loops;
a data analysis module to determine whether two or more of the respective ones of the plurality of subscriber loops experienced a common performance degradation during the time interval based on the first plurality of performance parameters; and
a trouble ticket submitter to generate a repair ticket when the two or more subscriber loops that experienced the respective performance degradation during the time interval are served from the common serving terminal, the repair ticket identifying the common performance degradation.

14. An apparatus as defined in claim 13, wherein the data analysis module comprises:
a line performance analyzer to compare each of the performance parameters to a threshold to determine whether the two or more of the respective ones of the plurality of subscriber loops experienced the common performance degradation during the time interval; and
a serving terminal analyzer to determine whether the two or more subscriber loops that experienced the performance degradation during the first interval are communicatively coupled to the common serving terminal.

15. An apparatus as defined in claim 13, further comprising a scheduler to initiate the data analysis module to detect and identify the common performance degradation.

16. An apparatus as defined in claim 13, wherein the common performance degradation is caused by a wideband noise created by a defective television.

17. An apparatus as defined in claim 13, wherein the first plurality of performance parameters represent aggregate performance characteristics for respective ones of the plurality of subscriber lines.

18. An apparatus as defined in claim 13, wherein the first plurality of performance parameters represent error counters for respective ones of the plurality of subscriber lines.

19. An apparatus as defined in claim 13, wherein the first plurality of performance parameters represent changes in maximum achievable data rates for respective ones of the plurality of subscriber lines.

20. An article of manufacture storing machine readable instructions which, when executed, cause a machine to:
retrieve a first plurality of performance parameters for a first time interval for respective ones of a plurality of digital subscriber line (DSL) modems, wherein each of the plurality of DSL modems are associated with respective ones of a plurality of subscriber loops;
compare each of the performance parameters to a threshold to determine whether two or more of the respective ones of the plurality of subscriber loops experienced respective performance degradations during the first time interval;
determine whether the two or more subscriber loops that experienced the respective performance degradations during the first time interval are communicatively coupled to a common serving terminal; and
automatically generate a repair ticket when the two or more subscriber loops that experienced the respective performance degradations during the first time interval are served from the common serving terminal, the repair ticket representing a possible wideband noise interference condition affecting more than one of the plurality of subscriber loops.

21. An article of manufacture as defined in claim 20, wherein the machine readable instructions, when executed, cause the machine to:
retrieve a second plurality of performance parameters for a second time interval for the respective ones of the plurality of DSL modems;
compare each of the performance parameters in the second plurality to the threshold to determine whether the two or more of the respective ones of the plurality of subscriber loops experienced respective performance degradations during the second time interval;
automatically update the repair ticket when the two or more subscriber loops that experienced the respective performance degradations during the second time interval are served from the common serving terminal.

22. An article of manufacture as defined in claim 20, wherein the possible wideband noise interference is caused by a defective television.

23. An article of manufacture as defined in claim 20, wherein the first plurality of performance parameters represent aggregate performance characteristics for respective ones of the plurality of subscriber lines.

24. An article of manufacture as defined in claim 20, wherein the first plurality of performance parameters represent error counters for respective ones of the plurality of subscriber lines.

25. An article of manufacture as defined in claim 20, wherein the first plurality of performance parameters represent changes in maximum achievable data rates for respective ones of the plurality of subscriber lines.

26. An article of manufacture as defined in claim 25, wherein the threshold represents a fifty percent decrease in a maximum achievable data rate.
